(19) United States
(12) Patent Application Publication
(10) Pub. No.: US 2015/0196162 A1
(43) Pub. Date: Jul. 16, 2015

(54) AUTOMATIC GRILL, IN PARTICULAR AN AUTOMATIC GRILL FOR EVENLY COOKING FOOD

(71) Applicant: Woodbees S.A.L., Metn (LB)

(72) Inventor: Assaad BOU HABIB, Cornet Chehwan (LB)

(73) Assignee: Woodbees S.A.L., Metn (LB)

(21) Appl. No.: 14/495,414

(22) Filed: Sep. 24, 2014

(30) Foreign Application Priority Data
Jan. 16, 2014 (LB) 10234

(51) Int. Cl. A47J 37/04

(52) U.S. Cl. CPC A47J 37/044

(57) ABSTRACT

Device for cooking food includes a food securing element, such as a skewer, for securing food to be cooked. A conveying element is provided for moving the food securing element relative to a heating device, such as a gas or electric grill, the conveying element moving at a predetermined rate of speed. Heating device may be provided for heating and cooking food on the food securing element, and a turning device is provided for turning the food securing element once as food securing element moves relative to the heating device, such as a gas burner. The turning device may be a rotating device which automatically turns the food securing element once in the range of 150 to 210 degrees, and, indeed, exactly 180 degrees, depending on the intended use.

### CROSS-REFERENCE TO RELATED APPLICATIONS

This application claims the priority of Lebanese application No. 10234, filed Jan. 16, 2014, which is incorporated herein by reference.

### FIELD OF THE INVENTION

The present invention relates to an automatic grill. More particularly, the invention relates to an automatic grill for evenly cooking food. Even more particularly, the invention relates to an automatic grill for automatically cooking food evenly on one side, then turning the food over once, and evenly cooking the food on the other side, so that an evenly cooked piece of food results.

### BACKGROUND OF THE INVENTION

Grills are known.

Automatic grills are known; indeed, automatic grills which continually rotate food are available in the marketplace.

Those PRIOR ART automatic grills often overcook food, cook food too much on one side, or cook food, such as meat, for such a long period of time that the cooked meat falls off skewers used in the automatic grill. That results in loss of cooked food and poor food quality.

### OBJECTS AND SUMMARY OF THE INVENTION

It is an object of the invention to overcome the drawbacks of the PRIOR ART.

It is another object of the invention to provide an automatic grill which cooks food, such as meat, so that it is evenly cooked each time meat is cooked on the automatic grill.

It is yet another object of the invention to provide an automatic grill which cooks food, such as grilled meat, only once per side; i.e., cooks the grilled meat on the lower side or face, and when the lower face facing a heating element is properly cooked, the meat is turned once so that the upper face (now the uncooked lower face when first turned and now facing the heating element) can be likewise cooked evenly yielding a properly consistently cooked product; e.g. piece of grilled meat.

It is another object of the invention to provide an automatic grill which is easier to use, requires less energy thanks to the use of the minimal required amount of fuel to cook the food as the food is cooked only as much as required on both of the two sides or faces, and avoids unwieldy sprockets and gears as in PRIOR ART devices.

It is yet a still further object of the invention to provide an automatic grill which no human intervention during the grilling process.

In sum, the invention is directed to a device for cooking food that includes a food securing element provided for securing food to be cooked, and a conveying element provided for moving the food securing element relative to a heating device, the conveying element moving at a predetermined rate of speed. A heating device is provided for heating food on the food securing element, and a turning device provided for turning the food securing element once as the food securing element is moved relative to the heating device.

The turning device may include a rotating element for rotating the food securing element once as the food securing element is moved relative to the heating device.

The food securing element may include a skewer, an arm may be provided on the skewer, and the turning device may engage and turn the arm for turning the skewer once. The turning device may turn the food once about 180° or in the range of about 150° to 210° when the food is cooked completely on one side.

Relative terms such as up, down, left, and right are for convenience only, and are not intended to be limiting.

### BRIEF DESCRIPTION OF THE DRAWINGS

FIG. 1 is a top front perspective view of an automatic grill according to an embodiment of the invention;

FIG. 2 is a top plan view of an embodiment of a skewer as used in the embodiment of the invention of FIG. 1;

FIG. 3 is a right side elevational view of the automatic grill of the embodiment of FIG. 1;

FIG. 4 is another embodiment of a skewer according to the invention;

FIG. 5 is a right side elevational view of another embodiment of the invention similar to the view of FIG. 3 in which the skewers are turned directly over; e.g., about 180°, when the skewers are turned for evenly cooking food;

FIG. 6 is a view similar to FIG. 5 showing a position of the skewers moved along further on the automatic grill during cooking;

FIG. 7 is a view similar to FIGS. 5 and 6 showing a still further advanced position of the skewers moved along the automatic grill during cooking; and

FIG. 8 shows a somewhat schematic side view of the embodiments of the automatic grill in which a cooling rack is provided for receiving the cooked food, such as grilled meat.

### DETAILED DESCRIPTION OF THE INVENTION

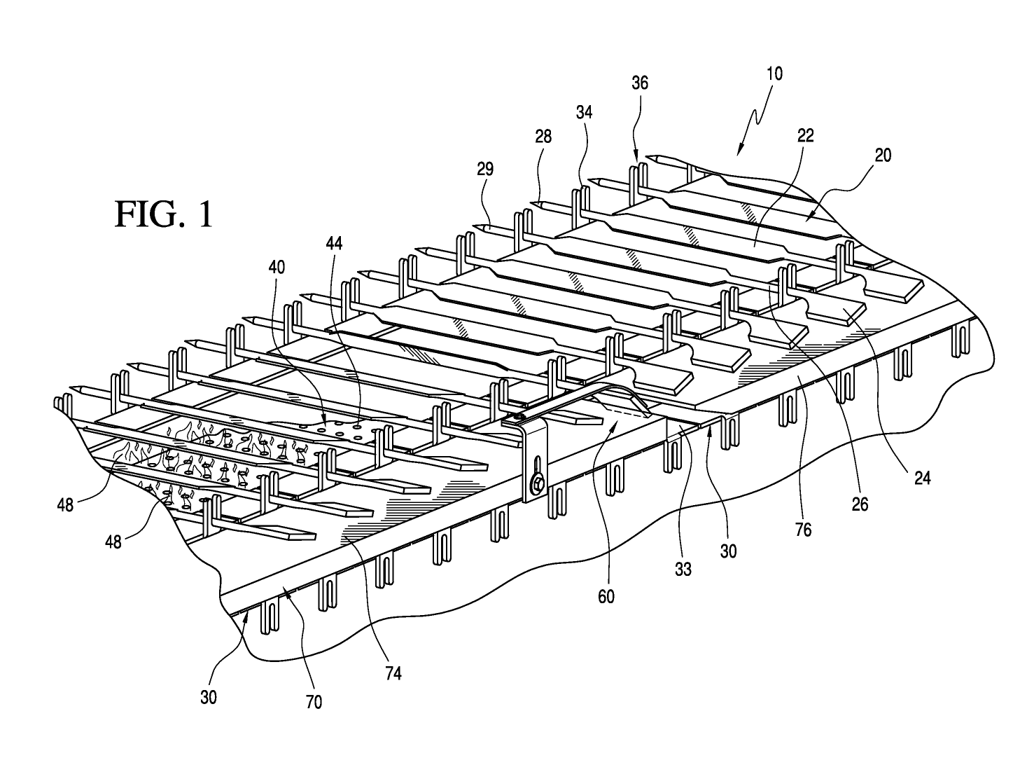

Grill 10 turning to FIGS. 1-3, a first embodiment of an automatic grill 10 according to the invention will now be described.

Grill 10 may include a food securing element 20, such as a skewer 20, which is sized and configured for securing food to be cooked, as well as for being automatically rotated for evenly cooking food in accordance with the invention, as will be described below.

Food securing element 20, shown as skewer 20 according to the invention, may include a flat portion 22 as well as an arm 24 provided on an end of an extension 26. A food piercing element 28, in the form of a pointed extension, may be provided on an end of an extension 29. The function of skewer 20 will be described in greater detail below in connection with the operation of automatic grill 10.

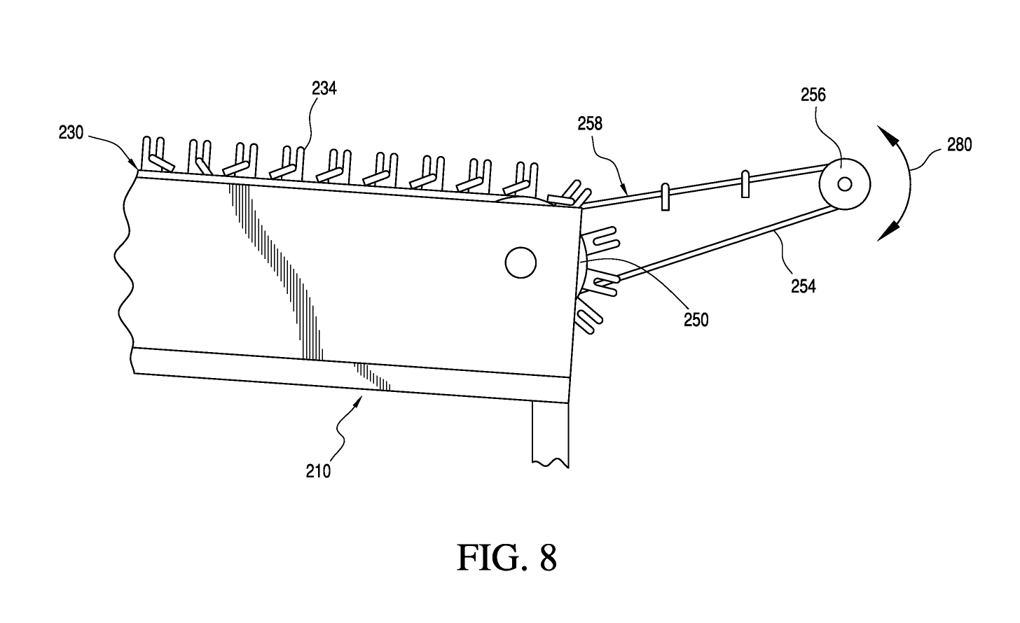

Grill 10 may further include a conveyor 30, shown in perspective view in FIG. 1 and in a side view in FIG. 3, and which may include one or more links 32, 33, as will be readily appreciated by a person having ordinary skill in the art. Conveyor 30, in use, may be driven by a drive, such as an electric motor, as described below in connection with FIG. 8.

Conveyor 30 may include skewer engaging elements 34, which define respective slots 36 for receiving respective ones of extensions 26 and 29 of skewer 20.

Automatic grill 10 may further include a heating device or element 40, such as an electric grill, or a gas grill 40, as shown, which may include one or more gas orifices or holes 44 through which a flammable gas such as natural gas or propane may be forced and ignited so that flames 48 are produced, as shown in FIG. 1, as will be readily understood. Gas flames 48 are located relative to skewers 20 and/or the size or intensity of flames 48 will be adjusted depending on the rate of speed of the conveyor and, hence, skewer 20 conveyed thereby, a relative to heating device 40, for cooking the food, such as meat, a desired amount.

Further, a turning device 60 may be provided for the turning of skewers 20 in the desired predetermined manner in accordance with the invention. Turning device 60 may include a rotating element, and the rotating or turning of skewers 20 by turning device 60 may be achieved with, for example, a guide 64, which may be curved, as shown, or straight, for example, depending on the configuration of the skewers 20, support 70, conveyor 30, and other components. Further, a protrusion or lead edge 68 may be provided on support 70, and may be located between a first rail 74 and a second rail 76, as shown. First and second rails 74, 76 may be spaced apart, as shown in FIGS. 1 and 3, and best seen in the middle of FIG. 3, for example. The space between first and second rails 74, 76 may be termed a gap 66 or turning gap for assisting with the turning of skewers 20 and or causing substantially all the turning of skewer 20 if guide 64 is omitted. With or without guide 64, gap 66 assists in the turning, or causes the turning, of skewer 20 in cooperation with the lead edge 64 which engages arm 24 as will be explained further below. In use, conveyor 30 will be moved in the direction of an arrow 100 as shown in FIG. 3.

To assist in an understanding of the manner in which automatic grill 10 evenly turns and cooks food secured on food securing element 20, upper and lower faces of skewer 20 and arm 24 will be described. Thus, as shown in FIG. 3, arm 24 may have an upper face 102 and a lower face 104, when viewed on the left side of conveyor 30; i.e., arms 24 show the position on the left side of turning device 60 as skewers 20 advance in direction 100 prior to be turned.

When skewer 20 moves along first rail 74 in direction 100, arms 24 maintain skewer 20 and flat food securing portion 22 in a substantially fixed position relative to heating device 40. In that manner, a first lower face of the food on flat portion 22 faces flames 48 and is cooked evenly at a predetermined rate of speed and flame intensity. As best seen in FIG. 3, face 104 of arm 24 faces downwardly as does respective lower face 108 of flat portion 22 (and food secured thereto). When arm 24 has been advanced sufficiently by conveyor 30, arm 24 engages guide 64 which ensures that upper face 102, as shown, will engage guide 64 and be rotated clockwise as viewed in FIG. 3 downwardly into turning gap 66 of turning device 60. As conveyor 30 further advances skewer engaging elements 34 to the right side of gap 66, it will be seen that what had been upper face 102 on the left side of the gap; that is, the first rail 74 side of gap 66, now engages extension 68. As will be readily understood, as conveyor 30 moves further to the right; i.e. in the direction of arrow 100, what had been upper face 102 rotates still further clockwise and becomes, in effect, lower face 102, as seen in the far right position of arm 24 on the far right side of FIG. 3; indeed, on the far right side of second rail 76 on which arm 24, and, hence, what is now lower face 102 of arm 24 rests. Thus, along rail 76 on the right side of turning device 60, what had been the upper, uncooked side of food secured on flat portion 22 now faces downwardly toward heating element 40 and is cooked in the desired fashion.

It may also be appreciated now by considering the position of skewers 20 on the left side of turning device 60 relative to the position of the skewers 20 on the right side of turning device 60 that the food has been rotated once about, for example, 180°+/−30°, in other words, about 150° to 210°. This embodiment of FIGS. 1 and 3 shows grill 10 according to the invention which turns food automatically once for evenly cooking, and specifically for grill uses with which one may want to vary the amount of turning of the food when it is turned once; or, for situations and types of food where the amount of turning is not critical; rather the fact that the foods is turned once is more important. It can be seen that this degree of rotation of about 150° (or 210° depending on one's point of view) is caused by an offset 114 between platform 70, that is between the top faces of first rail 74 and second rail 76 and extensions 26 of skewers 20.

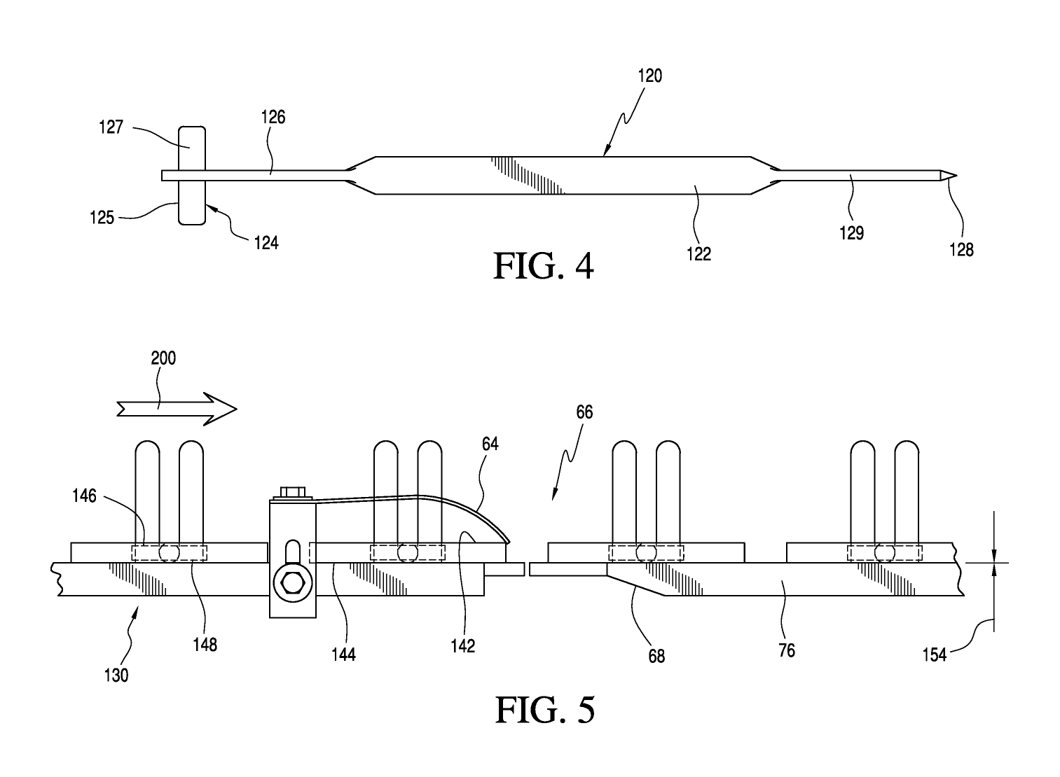

Turning now to FIG. 4, a further embodiment of a skewer 120 is shown, in which skewer 120 has a flat portion 122 for securing food in place, the flat portion being sized and configured for reducing or preventing rotation of food secured thereon relative to the skewer, in use. Skewer 120 includes an arm 124 having extension 125 and 127, and may be considered a double-sided arm. Extension 125, 127 may extend on opposite sides of extension 126, as shown. Further, the food piercing element 128 may be provided at the end of a further extension 129. Arm 124 and skewer 120 may have a one-piece construction analogous to arm 24 of skewer 20.

In use, a conveyor 130 according to the further embodiment of an automatic grill according to the invention has a similar function to that of the embodiment of FIGS. 1 and 3. A basic difference between the embodiment of FIGS. 5-7 and the embodiment of FIGS. 1 and 3 is that the food is rotated about 180° or indeed, exactly 180° when the food is rotated once on the automatic grill. That rotation of about 180° may be useful for food items, such as meat, for which it is known closely how long the meat should be cooked on one side, and it is known that the meat cooks evenly on one side and that when the lower face of the meat facing the heating element 40 when the meat is being cooked on the left side of the grill, such as shown in FIG. 1, it is known that it is important that the meat be cooked exactly on one face and then turned over and cooked exactly on the opposite face for the user's preference.

Thus, it will be appreciated that, in an analogous fashion to the embodiment of FIGS. 1 and 3, and the embodiment of the conveyor of FIGS. 5-7, the arm 124 has an upper face 142 and a lower face 144, and likewise the food securing element 122 has respective upper and lower faces 146, 148.

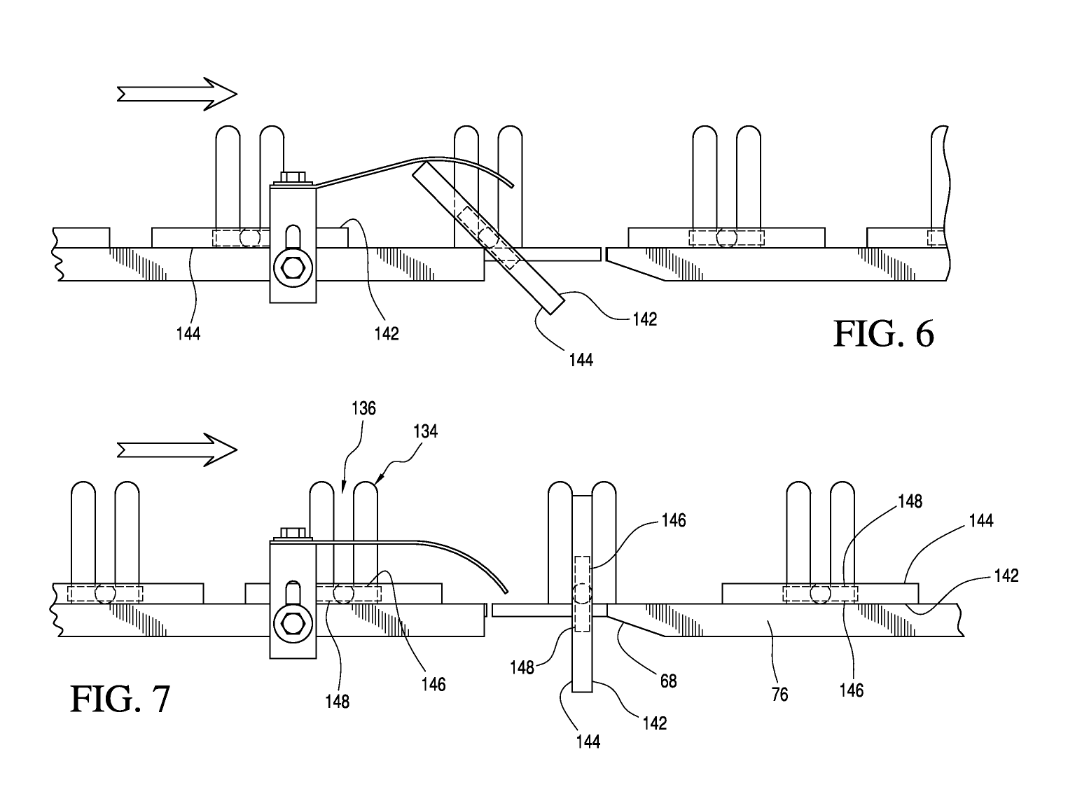

Thus, as conveyor 130 moves in direction 200, lower face 148 faces heating element 140, as does a first initially uncooked side of the food which likewise faces downward, faces heating element 40, and is cooked. At the same time, an upper face 146 and the respective upper face of the food secured on securing element 122 faces away from heating element 140 and remains uncooked. As conveyor 130 advances to the right in the direction of arrow 200 arm 124 engages food turning element 64 for ensuring that upper face 142 is turned clockwise along with food securing element 122 so that it achieves a rotated position as best appreciated by considering a FIG. 6 in which upper face 142 has been rotated and faces at an angle until it reaches a further position shown in FIG. 7. In that further or intermediate position it will be appreciated that skewer 120 has been rotated about 90° and initially upper face 142 faces leading edge 68. As conveyor 130 advances still further to the right, face 142, which had been the upper face, will, in a manner analogous to the rotation of skewer 20 as shown in FIG. 3 above, engage leading edge 68, and will be rotated further clockwise thereby, as conveyor 130 advances further to the right. Face 142 will then rest on the upper face of second rail 76 and will achieve the position at the far right side of FIG. 7 in which face 142 is now being conveyed substantially exactly facing downwardly in a position 180° opposite to its initial face up position of FIG. 6 when on the left side of turning gap 66. Likewise, face 146 of food securing flat portion 122 faces downwardly so what had been the uncooked upwardly facing portion of the food, such as meat, now faces downwardly for being cooked as it moves further along the length of conveyor 130 above heating element 40. It can be seen that this degree of rotation of about 180° is caused by there being little or no offset 154 between platform 70, that is between the top faces of first rail 74 and second rail 76 and extensions 126 of skewers 120.

It will be readily understood that the rate at which conveyors 30 and 130 move may be varied to achieve the exact amount of cooking desired on each face, the turning will be determined exactly to achieve the desired cooking, the overall length of conveyor 30, 130 will be varied, as well as the length of the conveyor on either side of turning device 60, so as to achieve desired result of evenly cooked food turned once automatically by grill 10 according to the various embodiments of the invention.

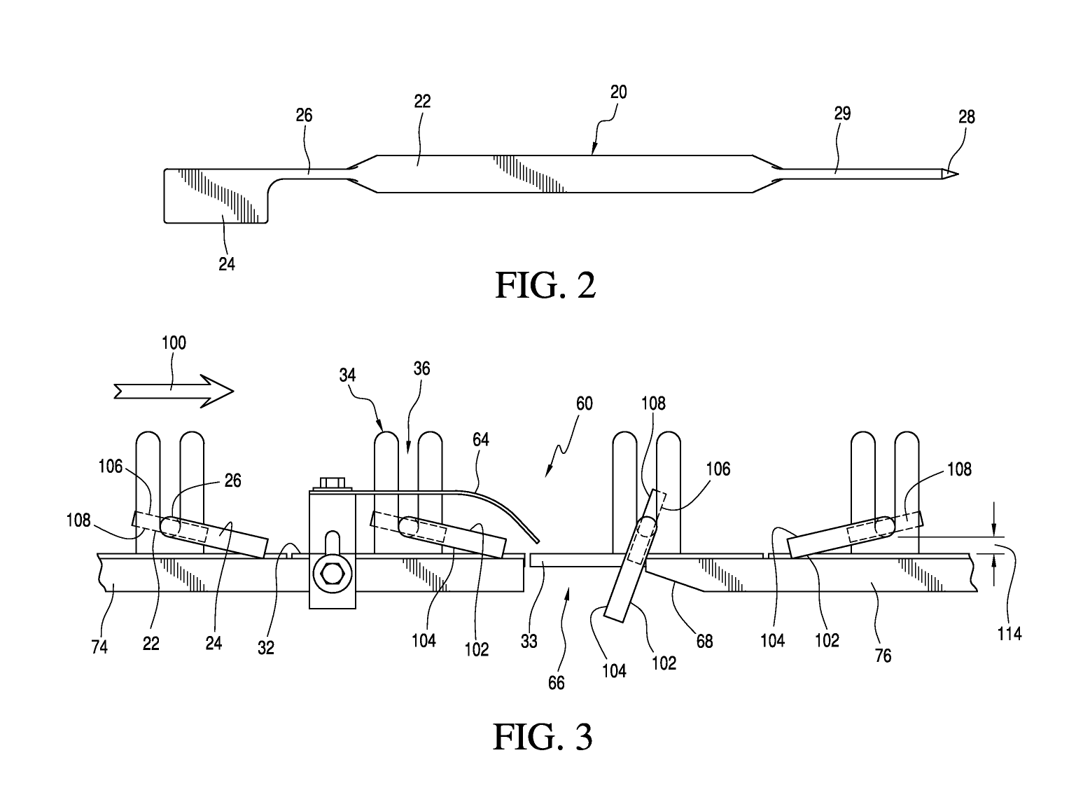

It will be still further appreciated that the skewer embodiments of FIGS. 2 and 4 may be used on either one of the conveyor embodiments according to the invention of FIGS. 1 and 3 and FIGS. 5-7.

Turning to FIG. 8, a schematic side view of a cooling conveyor is shown that is usable with all the embodiments of the conveyor according to the invention. That is, an end portion 210 of the grill according to the invention is shown in which there is a conveyor 230 and skewer engaging elements 234, driven by a drive 250, such as an electric drive motor for powering and driving conveyor 230 as will be readily appreciated.

Further, FIG. 8 shows the use of a cooling conveyor according to the invention having a chain or conveyor 254 on which the skewers are delivered on an upper cooling side 258 of the cooling conveyor. There may be a free wheel or idler 256 around which cooling chain or cooling conveyor 254 may rotate. Idler wheel 256 may be adjusted up and down in the direction of an arrow 280 so as to advance cooling skewers holding cooked food to a desired location.

It will be appreciated that a further rack or pan or other skewer collecting device may be provided, such as to the right of idler wheel 256 for collecting cooked and cooled food; it is omitted for clarity in the figure. It is further contemplated that the conveyor over the heating device of the grill may extend substantially horizontally, as shown, or may be angled upwardly or downwardly depending on the intended use.

While this invention has been described as having a preferred design, it is understood that it is capable of further modifications, and uses and/or adaptations of the invention and following in general the principle of the invention and including such departures from the present disclosure as come within the known or customary practice in the art to which the invention pertains, and as may be applied to the central features hereinbefore set forth, and fall within the scope of the invention.

What is claimed is:

1. A device for cooking food, comprising:
a) a food securing element provided for securing food to be cooked;
b) a conveying element provided for moving the food securing element relative to a heating device, the conveying element moving at a predetermined rate of speed;
c) a heating device provided for heating food on the food securing element; and
d) a turning device provided for turning the food securing element once as the food securing element is moved relative to the heating device.

2. Device as in claim 1, wherein:
a) the turning device includes a rotating element for rotating the food securing element once as the food securing element is moved relative to the heating device.

3. Device as in claim 1, wherein:
a) the food securing element includes a skewer.

4. Device as in claim 3, wherein:
a) a handle is provided on the skewer; and
b) the turning device engages and turns the handle for turning the skewer once.

5. Device as in claim 1, wherein:
a) the turning device turns the food once when food secured by the securing device is cooked completely on one side.

6. Device as in claim 1, wherein:
b) the turning device turns the food once about 180° when food secured by the securing device is cooked completely on one side.

7. Device as in claim 1, wherein:
c) the turning device turns the food once in a range of about 150° to 210° when food secured by the securing device is cooked completely on one side.
